(19) United States
(12) Patent Application Publication
(10) Pub. No.: US 2026/0152107 A1
(43) Pub. Date: Jun. 4, 2026

(54) FOOTREST DEVICE FOR SUPPORT MECHANISM AND CHILD CARRIER

(71) Applicant: Wonderland Switzerland AG, Steinhausen (CH)

(72) Inventor: Xiaolong MO, Guangdong (CN)

(73) Assignee: Wonderland Switzerland AG, Steinhausen (CH)

(21) Appl. No.: 19/406,449

(22) Filed: Dec. 2, 2025

(30) Foreign Application Priority Data
Dec. 3, 2024 (CN) 202411766380.X

(51) Int. Cl. B60N 3/06; B60N 2/28

(52) U.S. Cl. CPC B60N 3/063; B60N 2/286

(57) ABSTRACT

A footrest device for a support mechanism and a child carrier are provided. The footrest device for the support mechanism includes: a pedal portion; a connecting member surrounding the support mechanism and used for connecting the pedal portion to the support mechanism; and a locking member disposed on the connecting member. The locking member has a locked position for locking the footrest device to the support mechanism and an unlocked position for unlocking the footrest device from the support mechanism. The locked position and the unlocked position of the locking member are triggered by the pivoting the pedal portion relative to the connecting member. The pedal portion has an unfolded position and a folded position, or the pedal portion is detachably connected to the support mechanism.

### CROSS-REFERENCE TO RELATED APPLICATIONS

This application claims priority to Chinese Application No. 202411766380.X, entitled “footrest device for support mechanism and child carrier” and filed on Dec. 3, 2024, which is incorporated herein by reference in its entirety.

### TECHNICAL FIELD

The present disclosure relates to a footrest device for a support mechanism and a child carrier provided with the footrest device.

### BACKGROUND

A child carrier, such as a child safety seat, is a carrier specially designed for children. When a child is seated therein, the child is usually restrained in the child carrier in order to improve the child's safety. To prevent the safety seat from flipping over in a collision and reduce forward displacement of the safety seat during a collision so as to enhance safety, the child carrier is usually further provided with a support mechanism that extends from a front end of the safety seat to be fixed at a bottom of a vehicle.

However, conventional safety seats with support mechanisms on the market usually do not have a footrest function, leaving children's feet with no place to rest and hanging down during sitting, which greatly reduces the comfort of the child seated. In addition, some regulations clearly limit a width of the support mechanism of the safety seat to less than 200 mm, which also causes troubles for installing the footrest device.

### SUMMARY

In view of this, an objective of the present disclosure is to provide a footrest device for a support mechanism and a child carrier provided with the footrest device, so that a child can place their feet on the footrest device when riding, which greatly improves riding experience. Meanwhile, the support mechanism provided with the footrest device also meets the requirements of some regulations that limit the width to less than 200 mm.

To this end, according to one aspect of the present disclosure, there is provided a footrest device for a support mechanism, including: a pedal portion; a connecting member surrounding the support mechanism and configured to connect the pedal portion to the support mechanism; a locking member disposed to the connecting member, the locking member having a locked position for locking the footrest device to the support mechanism and an unlocked position for unlocking the footrest device from the support mechanism, wherein the locked position and the unlocked position of the locking member are triggered by pivoting the pedal portion relative to the connecting member, wherein the pedal portion has an unfolded position and a folded position, or the pedal portion is detachably connected to the support mechanism.

According to an embodiment, the pedal portion includes a movable plate and a stationary plate pivotally connected to each other, so that the movable plate is able to pivot around a first pivot axis relative to the stationary plate.

According to an embodiment, the connecting member includes a first connecting seat and a second connecting seat buckled to each other, each of the first connecting seat and the second connecting seat includes a buckling structure and a pivoting structure, and the buckling structure of the first connecting seat and the buckling structure of the second connecting seat are fixedly or detachably buckled to each other by a buckle to surround the support mechanism.

According to an embodiment, the pivoting structure of the first connecting seat is pivotally connected to the stationary plate through a first pivot seat, and the pivoting structure of the second connecting seat is pivotally connected to the stationary plate through a second pivot seat, whereby the stationary plate is pivotable around a second pivot axis relative to the connecting member, the second pivot axis is defined by a center connecting line of the first pivot seat and the second pivot seat and is perpendicular to the first pivot axis.

According to an embodiment, the footrest device further includes a clamping member connected to the connecting member, and the clamping member has a clamping position where the footrest device is clamped to the support mechanism and a releasing position where the footrest device is detached from the support mechanism.

According to an embodiment, the clamping member includes: an inner clamping element pivotally connected to the connecting member through a first pivot shaft; an outer clamping element pivotally connected to the connecting member through a second pivot shaft, in the clamping position, the inner clamping element pivots around the first pivot shaft relative to the connecting member along a first direction, the outer clamping element pivots around the second pivot shaft relative to the connecting member along a second direction different from the first direction, and the outer clamping element is pressed against outside of the inner clamping element and locked to the connecting member.

According to an embodiment, the locking member includes: a locking structure disposed on an inner peripheral surface of the connecting member opposite to the support mechanism, in the locked position, the locking structure protrudes from the inner peripheral surface to press against an outer side wall of the support mechanism, and in the unlocked position, the locking structure retracts into the inner peripheral surface; a mounting structure fixedly connected to the locking structure and connected to the connecting member; and a fixing structure, one end of which is connected to the locking structure through the mounting structure, and the other end of which is connected to the pedal portion.

According to an embodiment, a locking protrusion is disposed on a side of the locking structure opposite to the support mechanism; in the locked position, the locking protrusion protrudes from the inner peripheral surface of the connecting member to press against the outer side wall of the support mechanism; and in the unlocked position, the locking protrusion retracts into the inner peripheral surface.

According to an embodiment, a rotating slot and a connecting hole are disposed on an end surface of the connecting member opposite to the pedal portion, the fixing structure includes a limiting element (or stopper) and a fastener, the limiting element cooperates with the rotating slot and is connected to the pedal portion after passing through the rotating slot, the fastener is connected to the pedal portion after passing through the connecting hole, and is capable of triggering the limiting element to slide in the rotating slot by rotating the pedal portion to drive rotation of the locking structure.

According to the other aspect of the present disclosure, there is also provided a child carrier including: a seat body configured to carry a child; a base disposed below the seat body; a support mechanism pivotally connected to the base to be capable of having an unfolded position and a folded position, wherein the support mechanism is provided with the footrest device as above described.

According to the present disclosure, the support mechanism of the child carrier is provided with the footrest device, so that a child can place their feet on the footrest device when riding, and the height of the footrest device can be adjusted freely to facilitate the use of children of different ages and heights, improving riding comfort. Meanwhile, the footrest device can be folded or detached, thus meeting the requirements of some regulations on the width of the support structure. In addition, it is very simple to operate the support mechanism with the footrest device according to the present disclosure.

### BRIEF DESCRIPTION OF THE DRAWINGS

The accompanying drawings, which are incorporated into and constitute a part of this specification, illustrate embodiments consistent with the present disclosure, and serve to explain the principles of the present disclosure together with the description.

In the drawings,

FIG. 1 is a schematic view of a child carrier according to the present disclosure;

FIG. 2 is a schematic view showing the child carrier according to the present disclosure with a support mechanism folded;

FIG. 3 is a schematic view of the support mechanism of the child carrier according to the present disclosure, wherein a footrest device of the child carrier is in an unfolded position;

FIGS. 4 and 5 are schematic views of a footrest device of the child carrier according to the present disclosure;

FIG. 6 is an exploded schematic view of the footrest device of the child carrier according to the present disclosure;

FIG. 7 is a schematic view showing the footrest device of the child carrier according to the present disclosure, wherein a movable plate of the footrest device is in a folded position;

FIG. 8 is a schematic view showing the footrest device of the child carrier according to the present disclosure, wherein the footrest device is in a folded position;

FIG. 9 is a schematic view of a connecting member and a locking member of the child carrier according to the present disclosure;

FIGS. 10 and 11 are schematic views respectively showing the locking member of the child carrier according to the present disclosure in a locked state and an unlocked state, wherein FIG. 10 is a partial cross-sectional view taken along line A-A in FIG. 3;

FIGS. 12 and 13 are schematic views of a footrest device according to another embodiment of the child carrier of the present disclosure;

FIGS. 14 and 15 are schematic views showing a clamping member of the footrest device according to another embodiment; and

FIG. 16 is a schematic view showing a clamped state of the clamping member of the footrest device according to another embodiment.

```
1 child carrier
  10 seat body
  20 base
  30 support mechanism
    100 support tube
      110 first support tube
        111 first end 112 second end
      120 second support tube
        121 first end 122 second end
      130 engaging seat
    200 support foot
    300 footrest device
      310 pedal portion
        312 movable plate 3122 movable plate lug 3122a pivot shaft
        314 stationary plate 3142 stationary plate lug 3142a pivot hole
        315 footrest pad
        316 decorative pad
      320 connecting member
        321 first connecting seat
          3211 buckling structure 3211a buckle
          3212 pivoting structure 3212a rotating slot 3212b connecting hole
          3213 locking rib
        322 second connecting seat
          3221 buckling structure
          3222 pivoting structure 3222a rotating slot 3222b connecting hole
        325 first pivot shaft
        326 second pivot shaft
        327 inner peripheral surface
      330 locking member
        331 locking structure 3311 locking protrusion 3312 mounting protrusion
        332 mounting structure 3321 mounting slot
        333 fixing structure 3331 limiting element 3332 fastener
      340 first pivot seat
      350 second pivot seat
      360 clamping member
      361 inner clamping element 3611 accommodating slot 3612 clamping pad
      362 outer clamping element 3621 locking hook 3622 operating slot
  L1 first pivot axis
  L2 second pivot axis
```

### DETAILED DESCRIPTION

Hereinafter, exemplary embodiments will be described in detail with reference to the accompanying drawings. Although the present disclosure is susceptible to various modifications and alternative forms, specific embodiments thereof are shown by way of example in the drawings. However, the present disclosure should not be construed as being limited to the embodiments set forth herein; on the contrary, the present disclosure will cover all modifications, equivalents, and alternatives falling within the spirit and scope of the embodiments.

For the convenience of description, the following detailed description of the present disclosure mainly refers to a child safety seat, but the footrest device according to the present disclosure may also be applied to other child carriers.

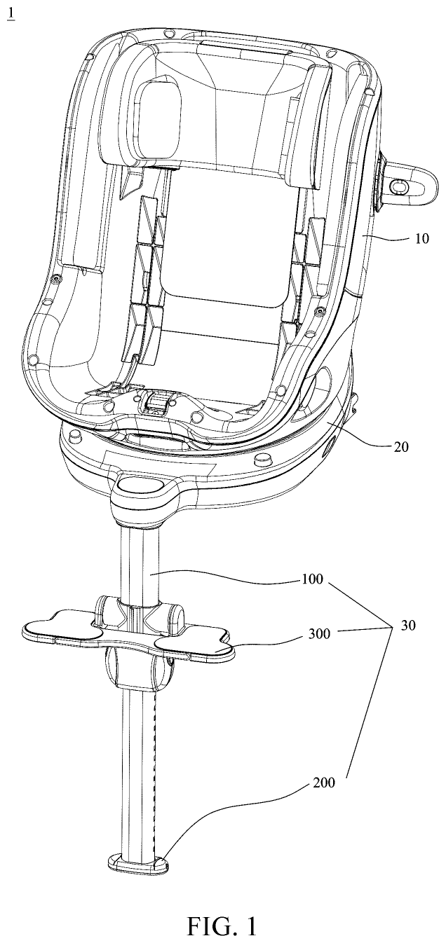

The child carrier 1 includes a seat body 10, a base 20, and a support mechanism 30. The seat body 10 is connected to the base 20, and the support mechanism 30 is disposed on the base 20. The support mechanism 30 includes a support tube 100 and a support foot 200 disposed at the bottom of the support tube 100. As shown in FIG. 1, taking a child safety seat as an example, the child carrier 1 includes a seat body 10 for carrying a child to provide safety protection during vehicle travel; the base 20 is disposed below the seat body 10, and the base 20 is mounted on a vehicle seat; to prevent the safety seat from flipping over in the event of an accidental collision and reduce the forward displacement of the safety seat during an accidental collision, the support mechanism 30 is further pivotally connected below the base 20, and the support mechanism 30 extends from a front end of the safety carrier 1 to be fixed at the bottom of the vehicle through the support foot 200, so as to provide more stable support for the child carrier 1. To solve the problem that children cannot place their feet during the ride, a footrest device 300 is connected to the support mechanism 30 according to the present disclosure.

In an embodiment, the footrest device 300 is disposed on the support tube 100 of the support mechanism 30. In an embodiment, as shown in FIG. 1, the footrest device 300 is sleeved on the support tube 100 of the support mechanism 30.

In an embodiment, the footrest device 300 may slide up and down along the support tube 100 of the support mechanism 30 to adjust the position of the footrest device 300, thereby facilitating the use of children of different ages and heights. In an embodiment, the footrest device 300 is capable of steplessly (infinitely) adjusting its height position along the support tube 100. That is to say, the footrest device 300 may be adjusted to any height position along the support tube 100.

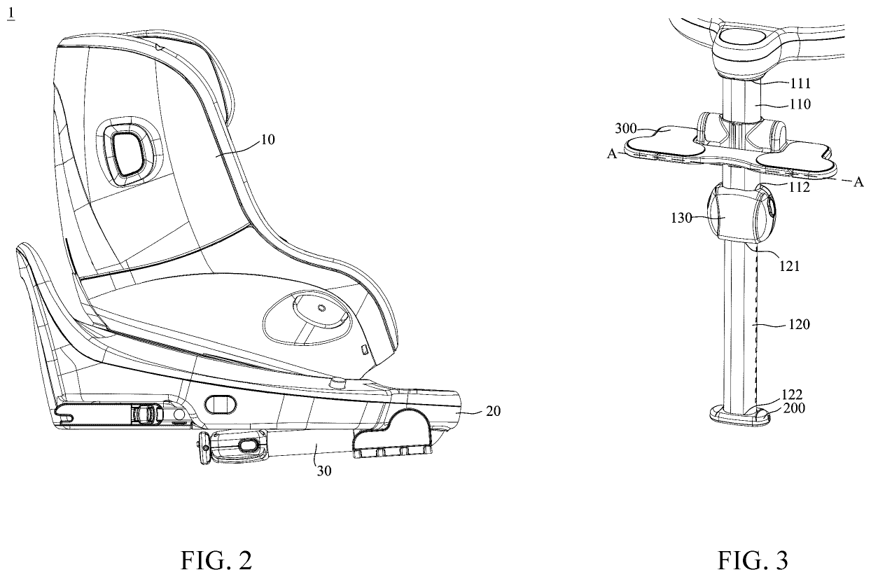

With reference to FIGS. 2 and 3, when not in use, the support mechanism 30 together with the footrest device 300 disposed thereon may be folded under the base to save space and facilitate storage. Further, the support tube 100 includes a first support tube 110 and a second support tube 120, which are sleeved with each other. For example, the first support tube 110 and the second support tube 120 are sleeved with each other through an engaging seat 130. The first support tube 110 may be received inside the second support tube 120, or the second support tube 120 may be received inside the first support tube 110. In this way, a length of the support tube 100 may be further shortened during storage, facilitating storage. According to an embodiment (not shown), a storage groove may be provided at the bottom of the base 20 to accommodate the stored support tube 100 and part of the footrest device 300, thereby reducing a height of the child carrier entirely after storage. In the embodiment shown in FIG. 3, the first end 111 of the first support tube 110 is pivotally connected to the base 20, the second end of the first support tube 110 is sleeved on the first end 121 of the second support tube 120 through the engaging seat 130, and the second end 122 of the second support tube 120 is connected to the support foot 200. However, the present disclosure is not limited thereto, and the support tube 100 may also be a three-section adjustable support tube. The footrest device 300 may be sleeved on the first support tube 110 on the upper part or the second support tube 120 on the lower part.

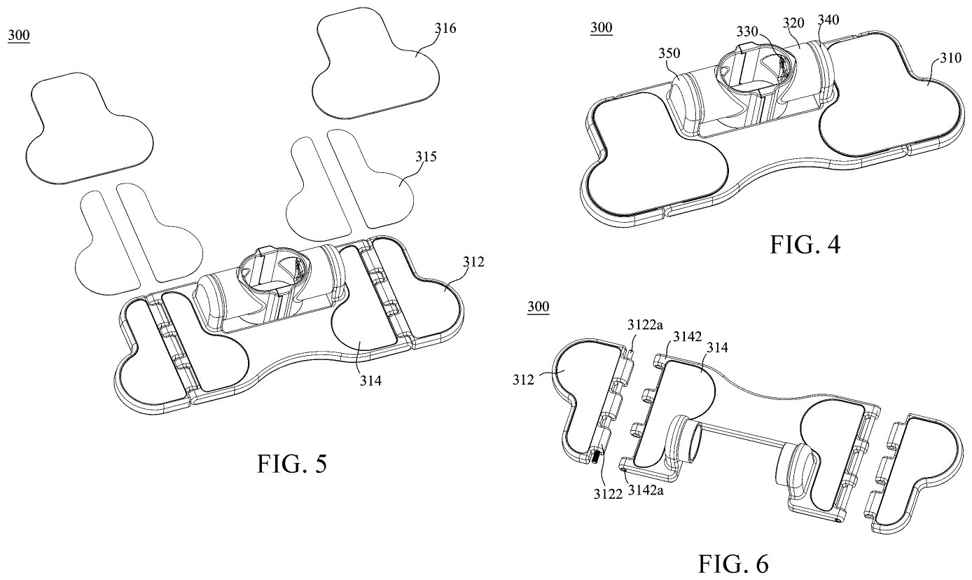

Next, the specific structure of the footrest device 300 will be further described with reference to FIGS. 4, 5, and 6.

The footrest device 300 according to the embodiment includes a pedal portion 310 and a connecting member 320. The pedal portion 310 is for the passenger to place their left and right feet. The pedal portion 310 is connected to the support tube 100 through the connecting member 320. For example, the pedal portion 310 may be slidably disposed on the support tube 110 through the connecting member 320 to adjust the height of the pedal portion 310.

In an embodiment, with reference to FIG. 3, the connecting member 320 surrounds the support tube 100, for example, surrounds an outer circumference of the first support tube 110. In an embodiment, specifically, as shown in FIG. 4, the pedal portion 310 may include left and right parts for the passenger to place their left and right feet respectively. The pedal portion 310 may surround the left, front, and right sides of the connecting member 320. A part of the pedal portion 310 facing the front of the child carrier may be wider than a part facing the rear of the child carrier, thereby providing sufficient space for the feet of the passenger to rest.

In an embodiment, as shown in FIG. 5, a footrest pad 315 is disposed on an upper surface of the pedal portion 310, and a decorative pad 316 is disposed above the footrest pad 315. The decorative pad 316 is usually made of a flexible material and has certain flexibility and anti-slip properties. A groove matching the shapes of the footrest pad 315 and the decorative pad 316 may also be formed on the upper surface of the pedal portion 310 to make the arrangement of the footrest pad 315 and the decorative pad 316 more fitting.

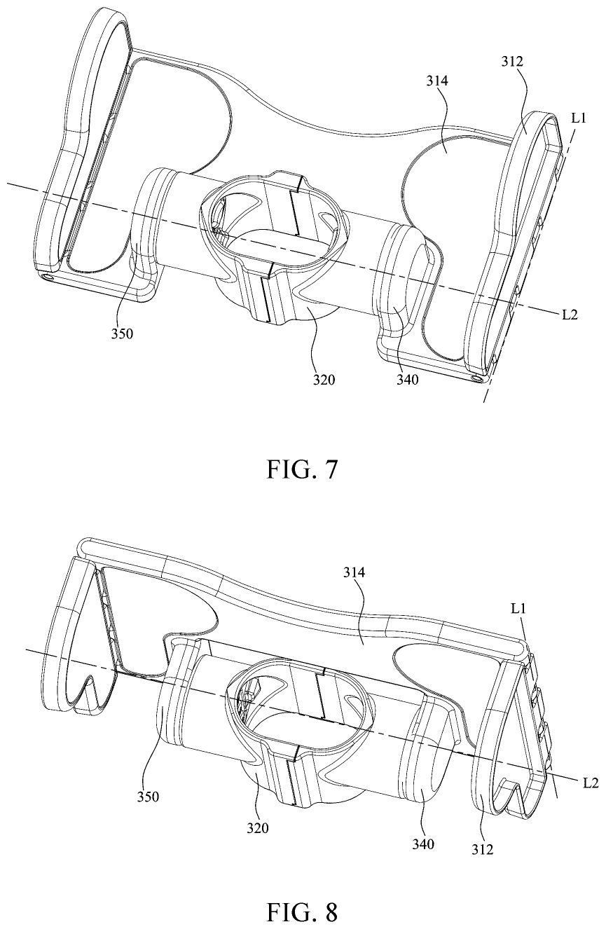

In an embodiment, the pedal portion 310 further includes a movable plate 312 and a stationary plate 314 pivotally connected to each other. With reference to the embodiment shown in FIG. 6, the movable plate 312 is provided with a movable plate lug 3122, and the stationary plate 314 is provided with a stationary plate lug 3142. A pivot hole 3142a is formed on the stationary plate lug 3142. The pivot shaft 3122a passing through the movable plate lug 3122 is inserted into the pivot hole 3142a of the stationary plate lug 3142 to pivotally connect the stationary plate 314 and the movable plate 312 to each other, so that the movable plate 312 is pivotable around a first pivot axis L1 (shown in FIG. 7) relative to the stationary plate 314.

In an embodiment, the pedal portion 310 may have a folded position and a use position. In the folded position, the pedal portion 310 is parallel to the support tube 100 of the support mechanism 30.

In an embodiment, in the use position, the pedal portion 310 is perpendicular to the support tube 100 of the support mechanism 30 to realize the footrest function of the footrest mechanism.

In an embodiment, in the folded position, a normal direction of a plane where the plate body of the pedal portion 312 is located is perpendicular to a tube length direction of the support tube 100 of the support mechanism 30.

In an embodiment, in the use position, the normal direction of the plane where the plate body of the pedal portion 310 is located is parallel to the tube length direction of the support tube 100 of the support mechanism 30.

In an embodiment, the footrest portion 310 may be pivotally disposed around the connecting member 320 to have the folded position and the use position.

Next, as shown in FIG. 8, a folded state of the footrest device 300 of the child carrier 1 according to the present disclosure is illustrated in FIG. 8. In terms of an orientation shown in FIG. 8, a right side of the connecting member 320 is connected to the stationary plate 314 of the pedal portion 310 through a first pivot seat 340, and a left side of the connecting member 320 is connected to the stationary plate 314 of the pedal portion 310 through a second pivot seat 350. A center connecting line of the first pivot seat 340 and the second pivot seat 350 defines a second pivot axis L2, which is perpendicular to the aforementioned first pivot axis L1. With such an arrangement, the movable plates 312 on both sides of the pedal portion 310 are pivotable and foldable around the first pivot axis L1 relative to the stationary plate 314, as shown in FIG. 7. This can reduce the overall width of the footrest device 300 to meet the requirements of some regulations that the width of the support mechanism must be less than 200 mm. In addition, as shown in FIG. 8, the stationary plate 314 of the pedal portion 310 may also pivot around the second pivot axis L2 relative to the connecting member 320 to place the pedal portion 310 in a stored position. Thus, when the support mechanism 30 is entirely folded as shown in FIG. 2, the pedal portion 310 in the stored position will not hinder the pivoting of the support tube 100, making the folding of the support mechanism 30 smoother and reducing the height of the entire child carrier 1 after folding.

The footrest device 300 according to an embodiment further includes a locking member 330 to lock the footrest portion 310 in the use position.

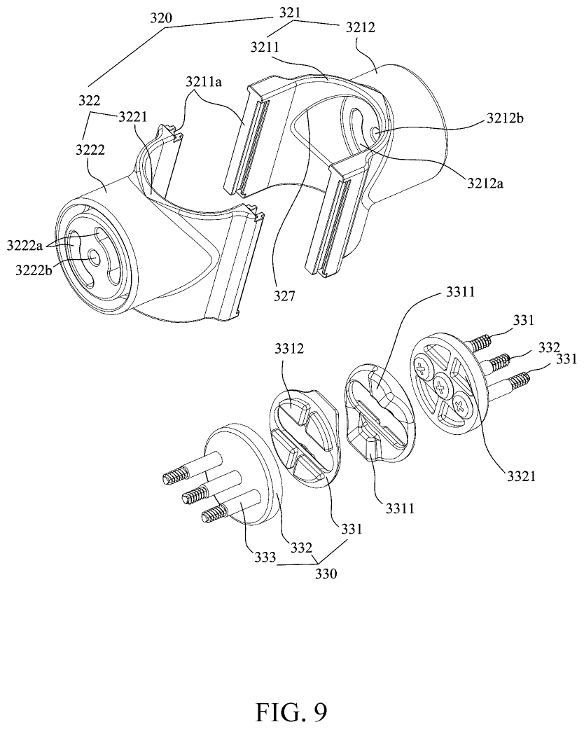

Next, the specific structures of the connecting member 320 and the locking member 330 according to an embodiment of the present disclosure will be described with reference to FIG. 9, which is a schematic view of the connecting member 320 and the locking member 330 of the child carrier 1 according to the present disclosure. According to the embodiment shown in FIG. 9, the connecting member 320 includes a first connecting seat 321 and a second connecting seat 322 buckled to each other. The structures of the first connecting seat 321 and the second connecting seat 322 are symmetrically arranged. Therefore, for brevity, only the specific structure of the first connecting seat 321 or the second connecting seat 322 will be described as an example below. The first connecting seat 321 includes a buckling structure 3211, and the second connecting seat 322 also includes a buckling structure 3221. Both the buckling structure 3211 of the first connecting seat 321 and the buckling structure 3221 of the second connecting seat 322 are generally approximately C-shaped, so that they form an elliptical or circular shape after being buckled to fit the outer peripheral shape of the support tube 100. The buckling structure 3211 of the first connecting seat 321 and the buckling structure 3221 of the second connecting seat 322 may be fixedly or detachably buckled to each other by a buckle 3211a to surround the support tube 100. In the embodiment shown in FIG. 9, the buckle 3211a is a tenon-and-mortise joints structure, so that the buckling structure 3211 of the first connecting seat 321 and the buckling structure 3221 of the second connecting seat 322 are non-detachable after being buckled to each other. However, the present disclosure is not limited thereto. The buckle 3211a may also be a matching screw and screw hole to achieve detachable connection, or the buckling structure 3211 of the first connecting seat 321 and the buckling structure 3221 of the second connecting seat 322 may be formed as an integral structure.

According to an embodiment, the first connecting seat 321 further includes a pivoting structure 3212. The pivoting structure 3212 is pivotally connected to the aforementioned first pivot seat 340 and connected to the pedal portion 310 through the first pivot seat 340. A rotating slot 3212a and a connecting hole 3212b are disposed on an end surface of the pivoting structure 3212 opposite to the pedal portion 310. According to the embodiment shown in FIG. 9, two rotating slots 3212a are provided, and both rotating slots 3212a are arc-shaped long slots and symmetrically arranged relative to the connecting hole 3212b.

Similarly, the second connecting seat 322 further includes a pivoting structure 3222. The pivoting structure 3222 is pivotally connected to the aforementioned second pivot seat 350 and connected to the pedal portion 310 through the second pivot seat 350. A rotating slot 3222a and a connecting hole 3222b are disposed on the end surface of the pivoting structure 3222 opposite to the pedal portion 310. According to the embodiment shown in FIG. 9, two rotating slots 3222a are provided, and both rotating slots 3222a are arc-shaped long slots and symmetrically arranged relative to the connecting hole 3222b.

With respect of the footrest device 300 according to an embodiment, the connecting member 320 may only include the first connecting seat 321. The first connecting seat 321 includes a buckling structure 3211, and the buckling structure 3211 of the first connecting seat 321 is generally approximately C-shaped to fit the outer peripheral shape of the support tube 100.

The locking member 330 according to the present disclosure is disposed on the connecting member 320 and has a locked position and an unlocked position. In the locked position of the locking member 330, the locking member 330 may lock the pedal portion 310 to the support tube 100 to facilitate the passenger to place their feet; in the unlocked position, the pedal portion 310 may slide up and down along the support tube 100 to be adjusted to an optimal position.

According to an embodiment, in the locked position of the locking member 330, the locking member 330 may lock the pedal portion 310 to the outer peripheral surface of the support tube 100; in the unlocked position of the locking member 330, the pedal portion 310 may slide up and down along the outer peripheral surface of the support tube 100 to be adjusted to the optimal position.

According to an embodiment, the locked position and the unlocked position of the locking member 330 may be triggered by pivoting the pedal portion 310 relative to the connecting member 320.

According to an embodiment, the locking member 330 includes at least one locking structure 331. The locking structure 331 is linked with the pedal portion 310, and the rotation of the pedal portion 310 may drive the rotation of the locking structure 331.

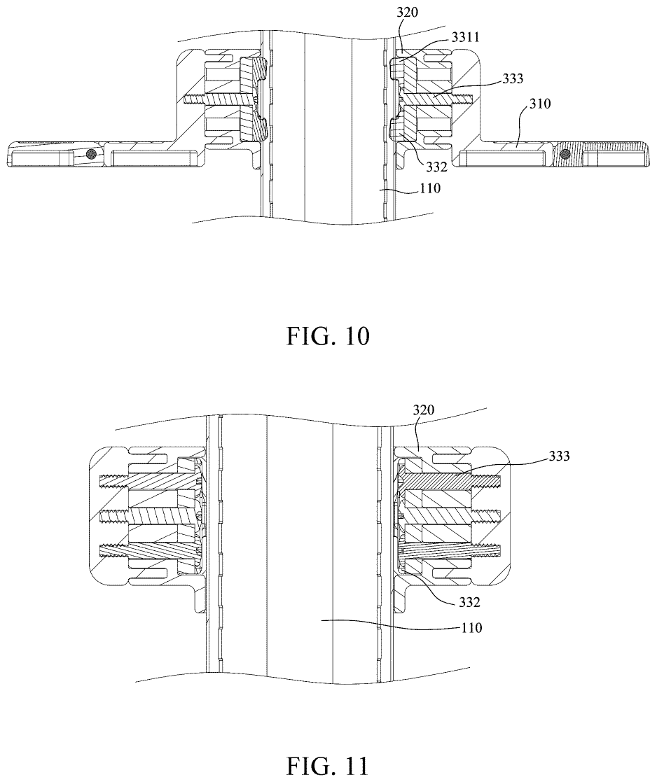

According to an embodiment, a locking protrusion 3311 is disposed on a surface of the locking structure 331 opposite to the support tube 100. When the locking structure 331 rotates to a position shown in FIG. 10, the locking protrusion 3311 of the locking structure 331 exposes an inner peripheral surface 327 of the connecting member 320 and thus presses against the outer peripheral surface of the support tube 100 accommodated in the connecting member 320, locking the footrest device 300 in this position. When the pedal portion 310 is rotated to drive the locking protrusion 3311 of the locking structure 331 to rotate to a position retracted into the inner peripheral surface 327 of the connecting member 320, as shown in FIG. 11, the footrest device 300 is unlocked and may be adjusted up and down along the support tube 100.

According to an embodiment, the locking structure 331 is disposed on the pivoting structure 3212 of the first connecting seat 321 or the pivoting structure 3222 of the second connecting seat 322.

Specifically, as shown in FIG. 9, the locking member 330 includes a locking structure 331, a mounting structure 332, and a fixing structure 333. According to the embodiment as shown, two locking structures 331 are provided, and correspondingly, two mounting structures 332 and two fixing structures 333 are also provided. The two locking structures 331 are respectively disposed on the pivoting structure 3212 of the first connecting seat 321 and the pivoting structure 3222 of the second connecting seat 322, and they are opposite to each other. Thus, when the first connecting seat 321 and the second connecting seat 322 of the connecting member 320 are fastened to each other through their respective buckling structures to surround the support tube 100, the two locking structures 331 are disposed on opposite two sides of the inner peripheral surface 327 of the connecting member 320 opposite to the support tube 100. A locking protrusion 3311 is disposed on the side surface of the locking structure 331 opposite to the support tube 100. For example, as shown in FIG. 9, two locking protrusions 3311 symmetrically arranged vertically may be provided, and the locking protrusion 3311 is preferably made of a soft rubber material, or the locking structure 331 is entirely made of a soft rubber material. A mounting protrusion 3312 is disposed on the side surface of the locking structure 331 opposite to the support tube 100. Correspondingly, a mounting slot 3321 is disposed on the side surface of the mounting structure 332 opposite to the locking structure 331. The locking structure 331 may be fixedly connected to the mounting structure 332 through an interference fit between the mounting protrusion 3312 and the mounting slot 3321. However, the present disclosure is not limited thereto, and other fixing connection methods may also be adopted. One end of the fixing structure 333 is fixed to the mounting structure 332 and thus to the locking structure 331, and the other end of the fixing structure 333 is connected to the pedal portion 310. For example, as shown in FIG. 9, the other end of the fixing structure 333 may be screwed into the pedal portion 310 through a threaded structure. Specifically, the fixing structure 333 includes a limiting element 3331 and a fastener 3332. The limiting element 3331 cooperates with a rotating slot 3212a disposed on the end surface of the pivoting structure of the connecting member 320 and is connected to the pedal portion 310, after passing through the rotating slot 3212a; the fastener 3332 is connected to the pedal portion 310, after passing through the connecting hole 3212b disposed on the end surface of the pivoting structure of the connecting member 320. Corresponding to the two symmetrically arranged arc-shaped long rotating slots 3212a, two limiting elements 3331 are also provided, and the two limiting elements 3331 are respectively inserted through the two rotating slots 3212a.

With the above structure, the rotation of the pedal portion 310 may trigger the limiting element 3331 to slide along the rotating slot 3212a, thereby driving the rotation of the locking structure 331. Specifically, with reference to FIGS. 10 and 11, FIG. 10 shows the locking member 330 in the locked state, and FIG. 11 shows the locking member 330 in the unlocked state. By rotating the pedal portion 310, the limiting element 3331 fixedly connected to the pedal portion 310 rotates along the rotating slot 3212a, and thusly driving the locking structure 331 fixedly connected to the mounting structure 332 to rotate. When the locking structure 331 rotates to the position shown in FIG. 10, combining to reference to FIG. 9, when the locking protrusion 3311 of the locking structure 331 rotates to the upper and lower positions, the locking protrusion 3311 will expose the inner peripheral surface 327 of the connecting member 320 and thus press against the outer peripheral surface of the support tube 100 accommodated in the connecting member 320, locking the footrest device 300 in this position. When it is necessary to adjust the position of the pedal portion 310, the pedal portion 310 needs to be rotated firstly, and the limiting element 3331 drives the locking protrusion 3311 of the locking structure 331 to rotate accordingly. For example, when rotated to the horizontal position, since the inner peripheral surface 327 of the connecting member 320 is an arc surface, the locking protrusion 3311 in the horizontal position may retract into the inner peripheral surface 327 of the connecting member 320, as shown in FIG. 11. At this time, the footrest device 300 is unlocked and may be adjusted up and down along the support tube 100. After adjusting to a suitable position, the footrest device 300 may be locked again by rotating the pedal portion 310.

The above-described footrest device 300 may be mounted on the support tube 100 of the child carrier 1, thereby providing a place for the passenger to place their feet and improving the riding experience. Meanwhile, the movable plate 312 of the pedal portion 310 is pivotable and foldable relative to the stationary plate 314, so that it can meet the requirements of some regulations that the overall width of the support mechanism is less than 200 mm. In addition, the height of the footrest device 300 can be adjusted freely, and the operation is simple.

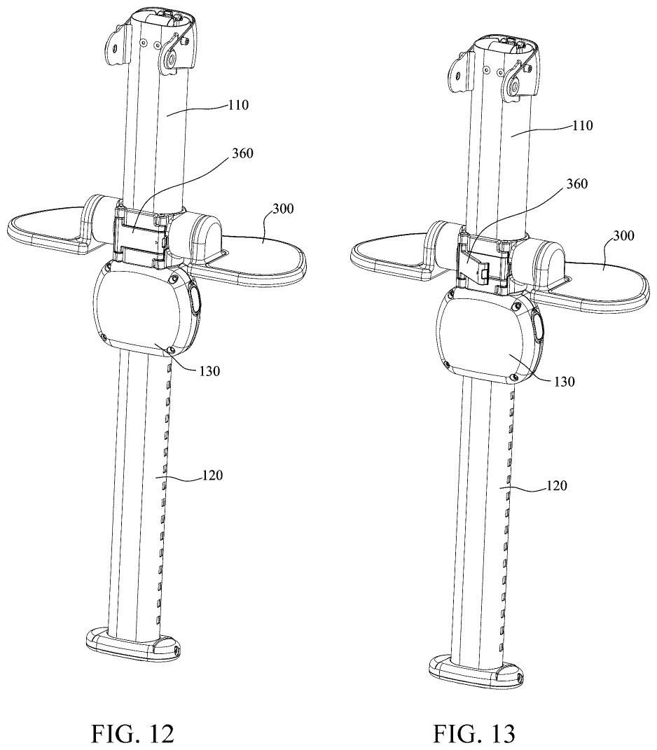

Next, a footrest device 300 according to another embodiment will be described with reference to FIGS. 12 and 13. The pedal portion 310 of the footrest device 300 in this embodiment is not foldable, but the footrest device 300 may be entirely connected to the support tube 100 through the clamping member 360 is in a clamped position, or detached from the support tube 100 through the clamping member 360 is in a released position. FIG. 12 shows the clamped position of the clamping member 360, where the footrest device 300 is connected to the support tube 100 for the passenger to place their feet; FIG. 13 shows a state where the clamping member 360 starts to open.

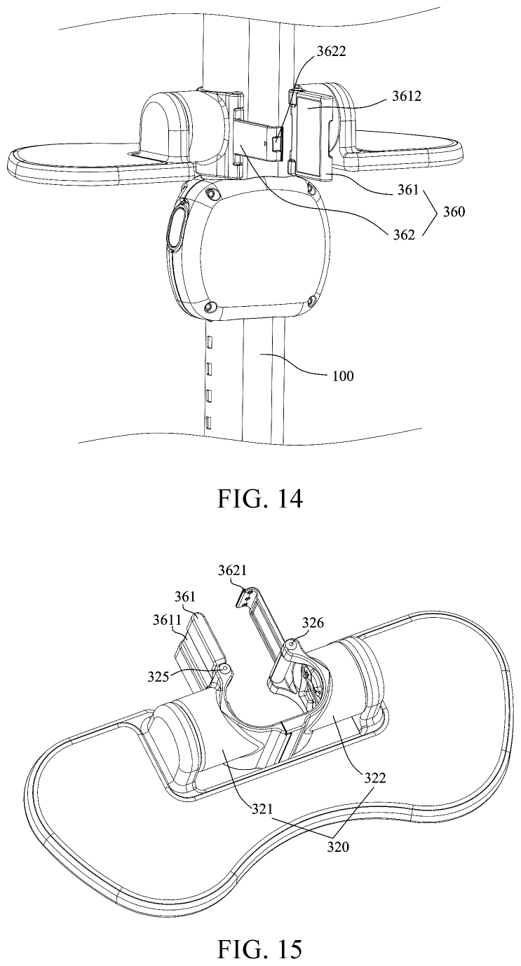

Specifically, as shown in FIGS. 14 and 15, which illustrate the specific structure of the clamping member 360, the clamping member 360 is connected to the connecting member 320, so that the connecting member 320 may be opened through the clamping member 360 to detach the footrest device 300. As shown in FIG. 15, the clamping member 360 includes an inner clamping element 361 and an outer clamping element 362. The inner clamping element 361 is pivotally connected to the connecting member 320, for example, pivotally connected to the first connecting seat 321 of the connecting member 320, through a first pivot shaft 325; the outer clamping element 362 is pivotally connected to the connecting member 320, for example, pivotally connected to the second connecting seat 322 of the connecting member 320, through a second pivot shaft 326. The structure of the connecting member 320 in this embodiment is basically the same as that of the connecting member 320 in the first embodiment described above, both including a first connecting seat 321 and a second connecting seat 322 buckled to each other. Each of the first connecting seat 321 and the second connecting seat 322 includes a buckling structure and a pivoting structure. Ends of the buckling structures are buckled to each other by a buckle. Different from the first embodiment is that the other ends of the buckling structure are not buckled to each other by a buckle as in the first embodiment, but pivotally connected with the inner clamping element 361 and the outer clamping element 362 through the first pivot shaft 325 and the second pivot shaft 326, respectively.

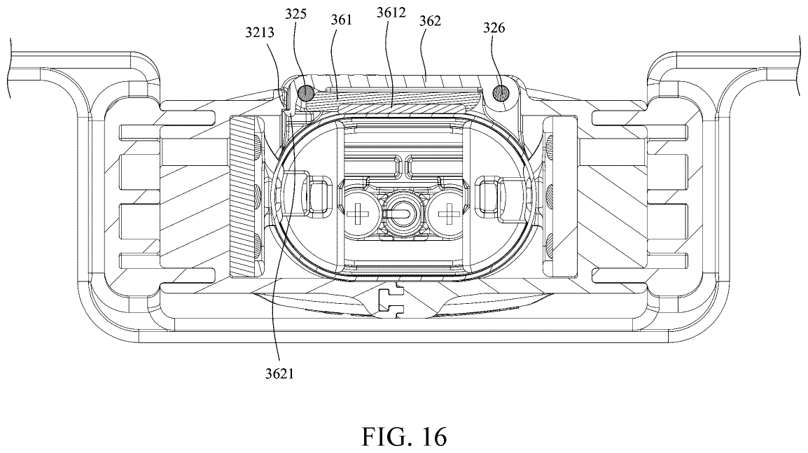

A clamping pad 3612 (shown in FIG. 14) is disposed on an inner surface of the inner clamping element 361 opposite to the support tube 100, and the clamping pad 3612 is preferably made of a soft rubber material. An accommodating slot 3611 (shown in FIG. 15) is disposed on an opposite outer surface of the inner clamping element 361. In the clamped position of the clamping member 360, the outer clamping element 362 may be partially accommodated in the accommodating slot 3611. Combining to reference to FIG. 16, a locking hook 3621 is disposed at one end of the outer clamping element 362 away from the second pivot shaft 326. Correspondingly, a locking rib 3213 (shown in FIG. 16) is disposed on the surface of the connecting member 320, for example, on the position of the surface corresponding to the first connecting seat 321. Based on the above structure, as shown in FIG. 15, the inner clamping element 361 may be pivoted clockwise around the first pivot shaft 325, so that the clamping pad 3612 of the inner clamping element 361 presses against the surface of the support tube 100 to form an interference fit, and the outer clamping element 362 may be pivoted counterclockwise around the second pivot shaft 326. The outer clamping element 362 clamps the inner clamping element 361 and may be partially accommodated in the accommodating slot 3611 disposed on the outer surface of the inner clamping element 361, and further enables the locking hook 3621 of the outer clamping element 362 to cooperate with the locking rib 3213 disposed on the connecting member 320, thereby locking the clamped state of the clamping member 360 and locking the footrest device 300 on the support tube 100.

An operating slot 3622 may also be disposed on the outer clamping element 362. The operating slot 3622 is preferably disposed near the locking hook 3621 to save effort and facilitate operation. Force may be applied through the operating slot 3622 to pivot the outer clamping element 362 in an opposite direction (for example, clockwise with reference to the figure of FIG. 15), and then the inner clamping element 361 is also pivoted in the opposite direction (for example, counterclockwise with reference to the figure of FIG. 15), so that the clamping member 360 may be released. At this time, the position of the footrest device 300 may be adjusted or the footrest device 300 may be detached. Certainly, in the clamped position of the clamping member 360, the rotation of the locking member 330 may be triggered by rotating the pedal portion 310 to adjust the height of the footrest device 300, and the operation process is the same as that of the first embodiment, which will not be repeated.

The structures of other components in this embodiment are the same as those in the first embodiment, and will not be described repeatedly.

The footrest device 300 according to this embodiment may be easily detached from the support tube 100, so there is no need to provide a movable plate and a stationary plate pivotally connected to each other, the structure is simpler, and it can also meet the requirements of some regulations that the overall width of the support mechanism is less than 200 mm. Its locking and unlocking operations are also very simple and easy to operate.

The present disclosure provides the footrest device for the support mechanism, including: a pedal portion; a connecting member surrounding the support mechanism and configured to connect the pedal portion to the support mechanism; a locking member disposed to the connecting member, the locking member having a locked position for locking the footrest device to the support mechanism and an unlocked position for unlocking the footrest device from the support mechanism, wherein the locked position and the unlocked position of the locking member are triggered by pivoting the pedal portion relative to the connecting member, wherein the pedal portion has an unfolded position and a folded position, or the pedal portion is detachably connected to the support mechanism.

According to an embodiment, the pedal portion includes a movable plate and a stationary plate pivotally connected to each other, so that the movable plate is pivotable around a first pivot axis relative to the stationary plate.

According to an embodiment, the connecting member includes a first connecting seat and a second connecting seat buckled to each other, each of the first connecting seat and the second connecting seat includes a buckling structure and a pivoting structure, and the buckling structure of the first connecting seat and the buckling structure of the second connecting seat are fixedly or detachably buckled to each other by a buckle to surround the support mechanism.

According to an embodiment, the pivoting structure of the first connecting seat is pivotally connected to the stationary plate through a first pivot seat, and the pivoting structure of the second connecting seat is pivotally connected to the stationary plate through a second pivot seat, whereby the stationary plate is pivotable around a second pivot axis relative to the connecting member, the second pivot axis is defined by a center connecting line of the first pivot seat and the second pivot seat and is perpendicular to the first pivot axis.

According to an embodiment, the footrest device further includes a clamping member connected to the connecting member, and the clamping member has a clamping position where the footrest device is clamped to the support mechanism and a releasing position where the footrest device is detached from the support mechanism.

According to an embodiment, the clamping member includes: an inner clamping element pivotally connected to the connecting member through a first pivot shaft; an outer clamping element pivotally connected to the connecting member through a second pivot shaft, in the clamping position, the inner clamping element pivots around the first pivot shaft relative to the connecting member along a first direction, the outer clamping element pivots around the second pivot shaft relative to the connecting member along a second direction different from the first direction, and the outer clamping element is pressed against outside of the inner clamping element and locked to the connecting member.

According to an embodiment, a clamping pad is disposed on the inner surface of the inner clamping element that presses against the support mechanism, and an accommodating slot is disposed on the outer surface of the inner clamping element opposite to the inner surface to accommodate the outer clamping element in the clamping position.

According to an embodiment, the clamping pad is made of a soft rubber material.

According to an embodiment, a locking hook is disposed at an end of the outer clamping element away from the second pivot shaft, a locking rib is disposed at a corresponding position of the connecting member, and the locking hook is capable of being locked to the locking rib to maintain the clamping position.

According to an embodiment, the connecting member is pivotally connected to the pedal portion through a first pivot seat and a second pivot seat respectively, so that the pedal portion is pivotable around a second pivot axis relative to the connecting member, and the second pivot axis is defined by a center connecting line of the first pivot seat and the second pivot seat.

According to an embodiment, the locking member includes: a locking structure disposed on an inner peripheral surface of the connecting member opposite to the support mechanism, in the locked position, the locking structure protrudes from the inner peripheral surface to press against an outer side wall of the support mechanism, and in the unlocked position, the locking structure retracts into the inner peripheral surface; a mounting structure fixedly connected to the locking structure and connected to the connecting member; and a fixing structure, one end of which is connected to the locking structure through the mounting structure, and the other end of which is connected to the pedal portion.

According to an embodiment, two locking structures are provided and disposed on opposite two sides of the inner peripheral surface of the connecting member opposite to the support mechanism, and two mounting structures and two fixing structures are provided correspondingly.

According to an embodiment, a mounting protrusion is disposed on a side of the locking structure opposite to the mounting structure, and a mounting slot is disposed at a corresponding position of the mounting structure, and the locking structure is fixedly connected to the mounting structure through a tight fit between the mounting protrusion and the mounting slot.

According to an embodiment, a locking protrusion is disposed on a side of the locking structure opposite to the support mechanism; in the locked position, the locking protrusion protrudes from the inner peripheral surface of the connecting member to press against the outer side wall of the support mechanism; and in the unlocked position, the locking protrusion retracts into the inner peripheral surface.

According to one embodiment, the locking structure is made of a soft rubber material.

According to an embodiment, a rotating slot and a connecting hole are disposed on an end surface of the connecting member opposite to the pedal portion, the fixing structure includes a limiting element and a fastener, the limiting element cooperates with the rotating slot and is connected to the pedal portion after passing through the rotating slot, the fastener is connected to the pedal portion after passing through the connecting hole, and is capable of triggering the limiting element to slide in the rotating slot by rotating the pedal portion to drive rotation of the locking structure.

According to an embodiment, the rotating slots are two arc-shaped slots symmetrically arranged relative to the connecting hole, and two limiting elements are correspondingly provided symmetrically arranged relative to the fastener.

According to an embodiment, the upper surface of the pedal portion is covered with a footrest pad, and the upper surface of the footrest pad is covered with a flexible decorative pad.

The present disclosure further provides a child carrier including: a seat body configured to carry a child; a base disposed below the seat body; a support mechanism pivotally connected to the base to be capable of having an unfolded position and a folded position, wherein the support mechanism is provided with the footrest device as above described.

According to an embodiment, the support mechanism includes a first support tube and a second support tube sleeved with each other through an engaging seat.

According to an embodiment, the first end of the first support tube is pivotally connected to the base, the second end of the first support tube is sleeved on the first end of the second support tube through the engaging seat, and the second end of the second support tube is connected to the support foot.

According to an embodiment, the footrest device is sleeved on the outer circumference of the first support tube and is capable of steplessly adjusting its height position along the first support tube.

Since the features of the present disclosure can be embodied in various forms without departing from the features thereof, it should also be understood that the above-described embodiments are not limited to any details described above, unless otherwise specified, but should be construed broadly as falling within the scope defined by the appended claims. Therefore, all modifications and variations that fall within the scope and boundaries of the claims or the equivalents of such scope and boundaries should be covered by the appended claims.

What is claimed is:

1. A footrest device for a support mechanism, comprising:
a pedal portion;
a connecting member surrounding the support mechanism and configured to connect the pedal portion to the support mechanism;
a locking member disposed to the connecting member, the locking member having a locked position for locking the footrest device to the support mechanism and an unlocked position for unlocking the footrest device from the support mechanism, wherein the locked position and the unlocked position of the locking member are triggered by pivoting the pedal portion relative to the connecting member,
wherein the pedal portion has an unfolded position and a folded position, or the pedal portion is detachably connected to the support mechanism.

2. The footrest device according to claim 1, wherein the pedal portion comprises a movable plate and a stationary plate pivotally connected to each other, so that the movable plate is pivotable around a first pivot axis relative to the stationary plate.

3. The footrest device according to claim 2, wherein the connecting member comprises a first connecting seat and a second connecting seat buckled to each other, each of the first connecting seat and the second connecting seat comprises a buckling structure and a pivoting structure, and the buckling structure of the first connecting seat and the buckling structure of the second connecting seat are fixedly or detachably buckled to each other by a buckle to surround the support mechanism.

4. The footrest device according to claim 3, wherein the pivoting structure of the first connecting seat is pivotally connected to the stationary plate through a first pivot seat, and the pivoting structure of the second connecting seat is pivotally connected to the stationary plate through a second pivot seat, whereby the stationary plate is pivotable around a second pivot axis relative to the connecting member, the second pivot axis is defined by a center connecting line of the first pivot seat and the second pivot seat and is perpendicular to the first pivot axis.

5. The footrest device according to claim 1, wherein the footrest device further comprises a clamping member connected to the connecting member, and the clamping member has a clamping position where the footrest device is clamped to the support mechanism and a releasing position where the footrest device is detached from the support mechanism.

6. The footrest device according to claim 5, wherein the clamping member comprises:
an inner clamping element pivotally connected to the connecting member through a first pivot shaft;
an outer clamping element pivotally connected to the connecting member through a second pivot shaft,
in the clamping position, the inner clamping element pivots around the first pivot shaft relative to the connecting member along a first direction, the outer clamping element pivots around the second pivot shaft relative to the connecting member along a second direction different from the first direction, and the outer clamping element is pressed against outside of the inner clamping element and locked to the connecting member.

7. The footrest device according to claim 6, wherein a clamping pad is disposed on the inner surface of the inner clamping element that presses against the support mechanism, and an accommodating slot is disposed on the outer surface of the inner clamping element opposite to the inner surface to accommodate the outer clamping element in the clamping position.

8. The footrest device according to claim 6, wherein a locking hook is disposed at an end of the outer clamping element away from the second pivot shaft, a locking rib is disposed at a corresponding position of the connecting member, and the locking hook is capable of being locked to the locking rib to maintain the clamping position.

9. The footrest device according to claim 5, wherein, the connecting member is pivotally connected to the pedal portion through a first pivot seat and a second pivot seat respectively, so that the pedal portion is pivotable around a second pivot axis relative to the connecting member, and the second pivot axis is defined by a center connecting line of the first pivot seat and the second pivot seat.

10. The footrest device according to claim 1, wherein the locking member comprises:
a locking structure disposed on an inner peripheral surface of the connecting member opposite to the support mechanism, in the locked position, the locking structure protrudes from the inner peripheral surface to press against an outer side wall of the support mechanism, and in the unlocked position, the locking structure retracts into the inner peripheral surface;
a mounting structure fixedly connected to the locking structure and connected to the connecting member; and
a fixing structure, one end of which is connected to the locking structure through the mounting structure, and the other end of which is connected to the pedal portion.

11. The footrest device according to claim 10, wherein a mounting protrusion is disposed on a side of the locking structure opposite to the mounting structure, and a mounting slot is disposed at a corresponding position of the mounting structure, and the locking structure is fixedly connected to the mounting structure through a tight fit between the mounting protrusion and the mounting slot.

12. The footrest device according to claim 10, wherein a locking protrusion is disposed on a side of the locking structure opposite to the support mechanism; in the locked position, the locking protrusion protrudes from the inner peripheral surface of the connecting member to press against the outer side wall of the support mechanism; and in the unlocked position, the locking protrusion retracts into the inner peripheral surface.

13. The footrest device according to claim 10, wherein a rotating slot and a connecting hole are disposed on an end surface of the connecting member opposite to the pedal portion, the fixing structure comprises a limiting element and a fastener, the limiting element cooperates with the rotating slot and is connected to the pedal portion after passing through the rotating slot, the fastener is connected to the pedal portion after passing through the connecting hole, and is capable of triggering the limiting element to slide in the rotating slot by rotating the pedal portion to drive rotation of the locking structure.

14. The footrest device according to claim 13, wherein the rotating slots are two arc-shaped slots symmetrically arranged relative to the connecting hole, and two limiting elements are correspondingly provided symmetrically arranged relative to the fastener.

15. The footrest device according to claim 13, wherein the upper surface of the pedal portion is covered with a footrest pad, and the upper surface of the footrest pad is covered with a flexible decorative pad.

16. A child carrier, comprising:
a seat body configured to carry a child;
a base disposed below the seat body;
a support mechanism pivotally connected to the base to be capable of having an unfolded position and a folded position,
wherein the support mechanism is provided with the footrest device according to claim 1.

17. The child carrier according to claim 16, wherein the support mechanism includes a first support tube and a second support tube sleeved with each other through an engaging seat.

18. The child carrier according to claim 17, wherein the first end of the first support tube is pivotally connected to the base, the second end of the first support tube is sleeved on the first end of the second support tube through the engaging seat, and the second end of the second support tube is connected to the support foot.

19. The child carrier according to claim 17, wherein the footrest device is sleeved on the outer circumference of the first support tube and is capable of steplessly adjusting its height position along the first support tube.
